(19) United States
(12) Patent Application Publication
(10) Pub. No.: US 2007/0021096 A1
(43) Pub. Date: Jan. 25, 2007

(54) Methods, systems, and computer program products associating communications detail records with a mobile reference and using the mobile reference to retrieve the communications detail records

(75) Inventor: Murat Arslan, Lutterbach (FR)

Correspondence Address: JENKINS, WILSON, TAYLOR & HUNT, P. A., 3100 TOWER BLVD, SUITE 1200, DURHAM, NC, 27707, US

(73) Assignee: Tekelec

(21) Appl. No.: 11/491,473

(22) Filed: Jul. 21, 2006

Related U.S. Application Data
(60) Provisional application No. 60/701,536, filed on Jul. 21, 2005.

(51) Int. Cl. H04Q 7/20

(52) U.S. Cl. 455/403

(57) ABSTRACT

Methods, systems, and computer program products for associating a mobile reference with communications detail records and for retrieving the communications detail records using the mobile reference are disclosed. According to one method, a plurality of different communications detail records for transactions involving a mobile station are generated. At least some of the communications detail records include different temporary mobile subscriber identifiers. The communications detail records are correlated based on the temporary mobile subscriber identifiers. A mobile reference is associated with each of the communications detail records. The communications detail records are accessed using the mobile reference.

### RELATED APPLICATIONS

This application claims the benefit of U.S. Provisional Patent Application Ser. No. 60/701,536, filed Jul. 21, 2005; the disclosure of which is incorporated herein by reference in its entirety.

### TECHNICAL FIELD

The subject matter described herein relates to generating and retrieving communications detail records. More particularly, the subject matter described herein relates to methods, systems, and computer program products associating communications detail records with a mobile reference and using the mobile reference to retrieve the communications detail records.

### BACKGROUND

In communications networks, it may be desirable to create one or more communications detail records (abbreviated herein as xDRs) based on transactions involving a mobile subscriber. For example, it may be desirable to generate records involving attachment of a mobile station to a network, update location transactions that occur when the mobile station changes locations in a network or roams between networks, call transactions regarding calls involving a mobile station, message transactions for short message service (SMS) or multimedia message service (MMS) services involving the mobile station, and handover transactions involving the mobile station.

In order to protect the mobile subscriber's identity, the permanent identifier for the mobile subscriber may not be transmitted in some of the messages involved in some of the transactions above. For example, in an initial update location transaction, in global system for mobile communications (GSM) networks, the international mobile subscriber identity (IMSI) may not initially be transmitted over the network when a mobile station attaches to the network. Instead, a mobile switching center/visitor location register (MSCNLR), upon detecting attachment of a mobile station, may assign a temporary mobile subscriber identity (TMSI) to the mobile subscriber and transmit the TMSI over the radio channel to the subscriber's mobile station until a secure channel can be established with the mobile station. Once a secure channel is established, the IMSI may be communicated from the mobile station to the MSCNLR. A new TMSI may be assigned when a subscriber changes location. Since a subscriber may change locations multiple times and may perform multiple calls or other transactions, multiple TMSIs may be associated with the subscriber. The IMSI and the current TMSI may be communicated to the new switch when the subscriber changes locations. However, the interface over which the IMSI is transmitted may not be observed by the monitoring system. As a result, disparate xDRs may be created, some of which may not include a permanent subscriber identifier, such as an IMSI.

For diagnostic purposes, it may be desirable to locate all records associated with the mobile subscriber in a given time period. Typically, records involving transactions by a mobile subscriber are stored in one or more databases. Retrieving the records involves performing forward and backward correlation based on the different TMSIs, which is a burdensome task. For example, forward correlation involves locating a TMSI in one record, locating another record that has the same TMSI, extracting a new TMSI from the newly located record, and then searching for the new TMSI. This process is repeated for a predetermined forward time period. Backward correlation is also required where records are searched backwards in time for successively assigned TMSI values. Such a process is labor and processor intensive.

One potential solution to locating records involving a mobile subscriber is to use the IMSI. However, as stated above, the IMSI may not be observed by the network monitoring system, depending on the location of network monitoring probes. FIG. 1 illustrates this problem. In FIG. 1, network monitoring probes 100, 102, and 104 monitor signaling messages on the lu-CS, lu-PS, and lu-PS interfaces associated with universal mobile telecommunications system (UMTS) network 106. UMTS network 106 includes radio network controllers (RNCs) 108 and 110. Each radio network controller is associated with one or more node Bs 112, 114, 116, and 118. Each node B may provide a radio interface to one or more cells, 120, 122, 124, and 126. In the example illustrated in FIG. 1, it should be noted that the Gb interface associated with general packet radio service (GPRS) network 128 is not monitored. GPRS network 128 includes a base station controller 130, one or more base transceiver stations 132 and 134, and one or more cells 136 and 138.

In the core network, the example in FIG. 1 includes a serving GPRS support node (SGSN) 140 serving GPRS network 128, an SGSN 142 serving UMTS network 106, a gateway GPRS support node (GGSN) 144, a home location register (HLR) 146, a gateway mobile switching center 148, a mobile switching center 150, and a visitor location register 152. Signaling messages exchanged between the core network and UMTS network 106 will be observed by monitoring probes 100, 102, and 104. However, signaling messages transmitted between GPRS network 128 and the core network will not be observed because the Gb interface is not monitored. Accordingly, when a mobile subscriber moves from network 128 to network 106, the message including the IMSI that is transmitted over the Gb interface will not be observed. As a result, monitoring interfaces 100, 102, and 104 will only detect signaling messages associated with TMSIs in the transaction. Since there is no permanent identifier assigned to the mobile subscriber that is detected by the monitoring points, the detailed correlation described above will be required to be performed when a diagnostic application seeks to extract records corresponding to the mobile subscriber.

Accordingly, in light of these difficulties associated with conventional communications network monitoring, there exists a need for methods, systems, and computer program products associating communications detail records with a mobile reference and using the mobile reference to retrieve the communications detail records.

### SUMMARY

Methods, systems, and computer program products for associating a mobile reference with communications detail records and retrieving the communications detail records using the mobile reference are disclosed. According to one method, a plurality of different communications detail records for transactions involving a mobile station are generated. At least some of the communications detail records include different temporary mobile subscriber identifiers. The communications detail records are correlated based on the temporary mobile subscriber identifiers. A mobile reference is associated with each of the communications detail records. The communications detail records are accessed using the mobile reference.

As used herein, the term “communications detail record” refers to any record generated based on signaling messages involving a transaction related to a mobile station. A communications detail record may include parameters extracted from one or more signaling messages associated with a transaction in a mobile communications network. Examples of communications detail records that may be generated include call detail records, attachment detail records, location update records, SMS records, MMS records, handover records, or records involving another transaction with a mobile station.

As used herein, the term “mobile reference” refers to an identifier assigned by network monitoring equipment to identify a subscriber. The mobile reference may be assigned independently from permanent subscriber identifiers, such as the IMSI, used by network signaling nodes to identify the subscriber. However, any identifier, including the IMSI, may be used as the mobile reference without departing from the scope of the subject matter described herein.

As used herein, the term “temporary mobile subscriber identifier” refers to any identifier used by the network to temporarily identify a mobile subscriber. Examples of temporary mobile subscriber identifiers include TMSIs, packet TMSIs (PTMSIs), PDP IP addresses, temporary logical link identifiers (TLLIs), S-RNTIs, C-RNTIs, and U-RNTIs. S-RNTIs, C-RNTIs, and U-RNTIs respectively refer to serving, controlling, and UTRAN RNC radio network temporary identifiers used in UMTS networks to temporarily identify a mobile station. A PDP IP address is a packet data protocol IP address used in UMTS or GPRS networks to temporarily identify a mobile station. A TLLI identifies a GPRS subscriber. Within a routing area, there is a unique association between the TLLI and IMSI known in the mobile equipment and the SGSN. The TLLI is derived from the PTMSI, which is allocated by the SGSN. As stated above, a TMSI is an identifier used in GSM or UMTS networks to temporarily identify a mobile station. A P-TMSI is a TMSI used to identify a subscriber in a packet network, such as the UMTS network.

As indicated above, two types of RNTIs are the S-RNTI, which is used within the serving RNC, and the C-RNTI, which is used within a cell controlled by a controlling radio network controller (CRNC), when applicable. The S-RNTI is allocated for all user equipment (UE) (e.g., mobile stations) having a radio resource channel (RRC) connection. The S-RNTI is allocated by the serving RNC and is unique within the serving RNC. The S-RNTI is reallocated when the serving RNC for the RRC connection is changed and deallocated when the RRC connection is released.

In addition, for each UE having an RRC connection, there is an identifier of its current serving RNC, which is denoted as SRNC identifier. The SRNC identifier together with S-RNTI is a unique identifier of the RRC connection within a public land mobile network (PLMN). The combination of SRNC identifier and S-RNTI is referred to as U-RNTI (UTRAN Radio Network Temporary Identity), which is used on the radio interface.

The C-RNTI for a UE is allocated by a controlling RNC and it is unique within one cell controlled by the allocating CRNC. The C-RNTI can be reallocated when a UE accesses a new cell with the cell update procedure. Usage of UE identifiers

The U-RNTI is allocated to mobile station having a RRC connection. It identifies the UE within the UTRAN and is used as a mobile station identifier in cell update, UTRAN registration area (URA) update, RRC connection reestablishment and (UTRAN originated) paging messages and associated responses on the radio interface. The SRNC identifier within the U-RNTI is used by the controlling RNC to route the received uplink messages towards the serving RNC.

The C-RNTI is used as a mobile station identifier in all other dedicated control channel/dedicated traffic channel (DCCH/DTCH) common channel messages on the radio interface.

Network access server (NAS) identifiers are used as the UE identifier in the initial access CCCH message on the radio interface.

Generating xDRs by correlating messages using any of these identifiers and assigning a mobile reference to the generated xDRs is intended to be within the scope of the subject matter described herein.

As used herein, the term “permanent mobile subscriber identifier” refers to any identifier used by the network to permanently identify a mobile station and/or a mobile subscriber. One example of a permanent mobile subscriber identifier is an IMSI.

The subject matter described herein for associating communications detail records with a mobile reference and for extracting the records using the mobile reference may be implemented using a computer program product comprising computer executable instructions embodied in a computer readable medium. Exemplary computer readable media suitable for implementing the subject matter described herein include chip memory devices, disk memory devices, programmable logic devices, application specific integrated circuits, and downloadable electrical signals. In addition, a computer program product that implements the subject matter described herein may be located on a single device or computing platform or may be distributed across multiple devices or computing platforms.

### BRIEF DESCRIPTION OF THE DRAWINGS

Preferred embodiments of the subject matter described herein will now be explained with reference to the accompanying drawings of which:

FIG. 1 is a block diagram illustrating a telecommunications network in which it may be desirable to use a mobile reference to associate and retrieve communications detail records according to an embodiment of the subject matter described herein;

FIG. 2 is a block diagram of the network illustrated in FIG. 1 illustrating transactions for which it may be desirable to use a mobile reference to associate a retrieved communications detail records according to an embodiment of the subject matter described herein;

FIG. 3 is a data flow diagram illustrating exemplary messages for which it may be useful to use a mobile reference to associate and retrieve communications detail records according to an embodiment of the subject matter described herein;

FIG. 4 is a data flow diagram illustrating the association of a mobile reference with different communications detail records according to an embodiment of the subject matter described herein;

FIG. 5 is a data flow diagram illustrating mobile reference allocation according to embodiment of the subject matter described herein;

FIG. 6 is a data flow diagram illustrating mobile reference allocation when a permanent identifier is observed according to an embodiment of the subject described herein;

FIG. 7 is a block diagram illustrating exemplary system for associating communications detail records with a mobile reference and for retrieving the communications detail records using the mobile reference according to an embodiment of the subject matter described herein; and

FIG. 8 is a flow chart illustrating an exemplary process for associating a mobile reference with communications detail records and retrieving the records using mobile reference according to an embodiment of the subject matter described herein.

### DETAILED DESCRIPTION OF THE INVENTION

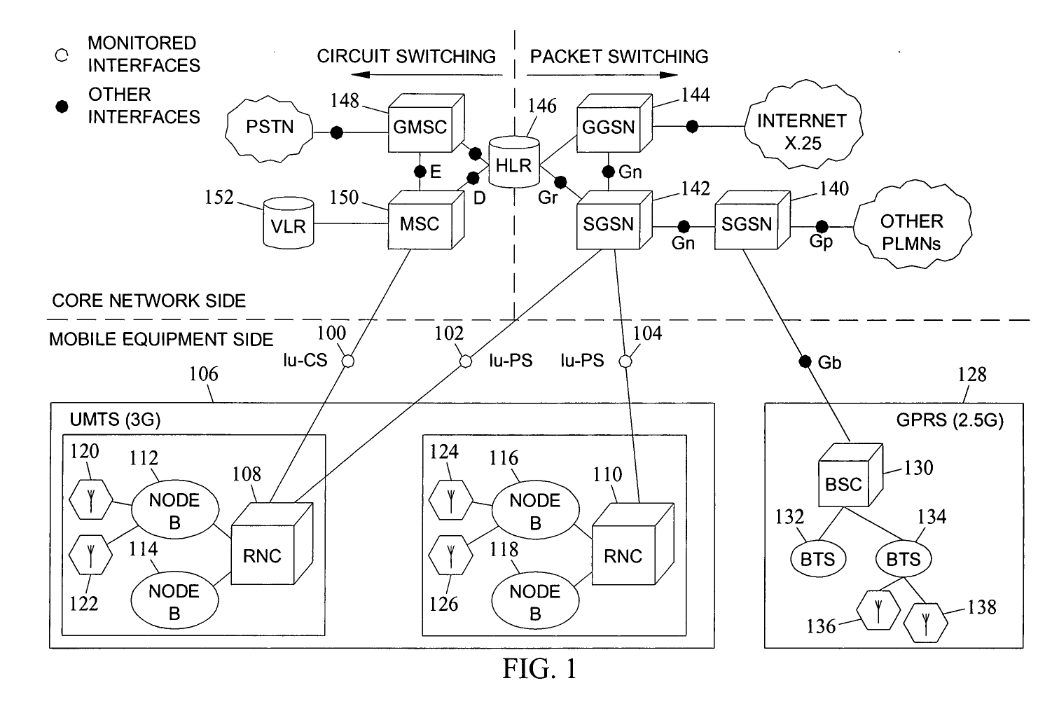

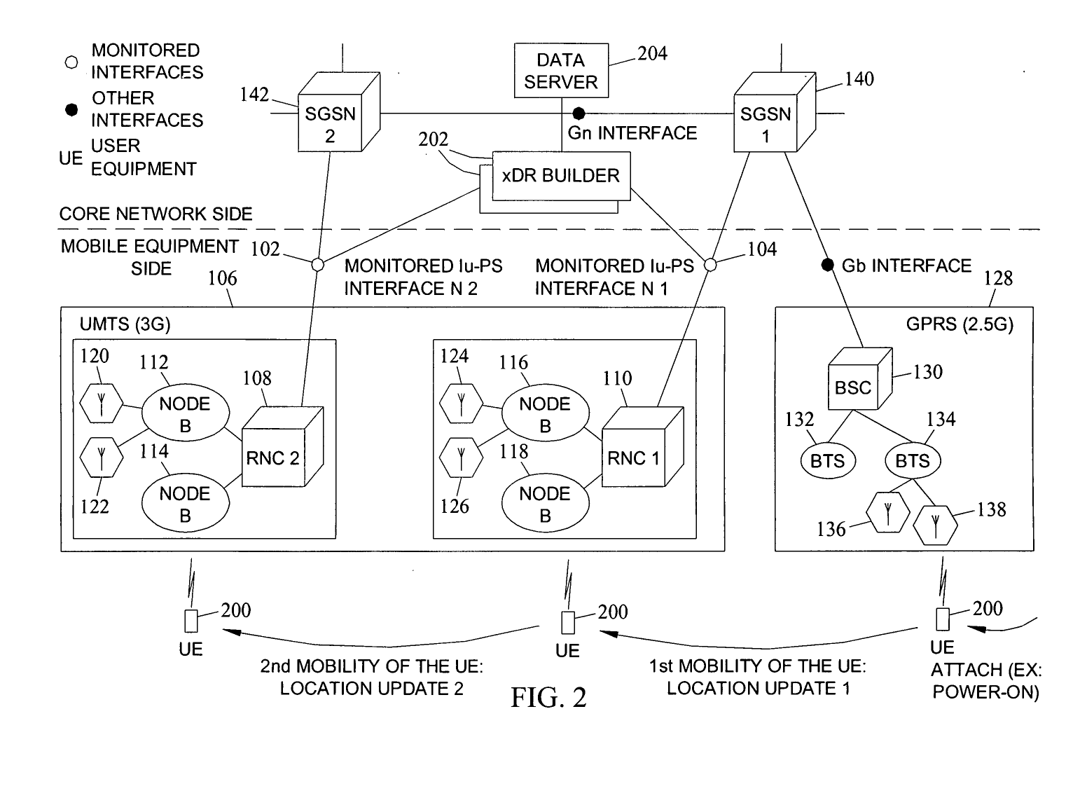

The subject matter described herein includes methods, systems, and computer program products for associating communications detail records with a mobile reference and for using the mobile reference to retrieve communications detail records. FIG. 2 is a diagram of a network similar to that illustrated in FIG. 1 where the Gb interface associated with the GPRS network is not monitored. Link probes 102 and 104 may monitor the lu-PS interfaces associated with UMTS network 106. Accordingly, when user equipment 200 which is on his or hers mobile phone and attaches to the GPRS network 128, monitoring probes 102 and 104 do not observe the messages.

When user equipment 200 moves to GPRS network 106, user equipment 200 initiates an update location transaction into the monitored part of the network. SGSN 140 already knows the permanent identifier or IMSI of the mobile subscriber, but may not transmit the IMSI over the network through the lu-PS interface N1. Instead, SGSN 140 may only use the temporary identifications allocated by RNC 110. These messages will be collected by link per 104 and communicated to xDR builders 202. Each xDR builder 202 may generate one or more xDRs and communicate the xDRs to a data server 204. As will be described in more detail below, data server 204 may associate the xDRs with a mobile reference.

In the illustrated example, when the user equipment updates again, by moving to the area managed by RNC 108, another update location message is generated. This time, the new SGSN, SGSN 142, does not know the permanent ID of the mobile station. SGSN 142 can obtain the permanent identifier from SGSN 140. However, the permanent identifier may not be transmitted over the lu-PS network and the monitoring system may continue to generate xDRs without the permanent identifier. However, as described above, one or more components of data server 204 may allocate a mobile reference to the mobile subscriber, associate the mobile reference with xDRs concerning the subscriber, and use the mobile reference to retrieve all records associated with subscriber.

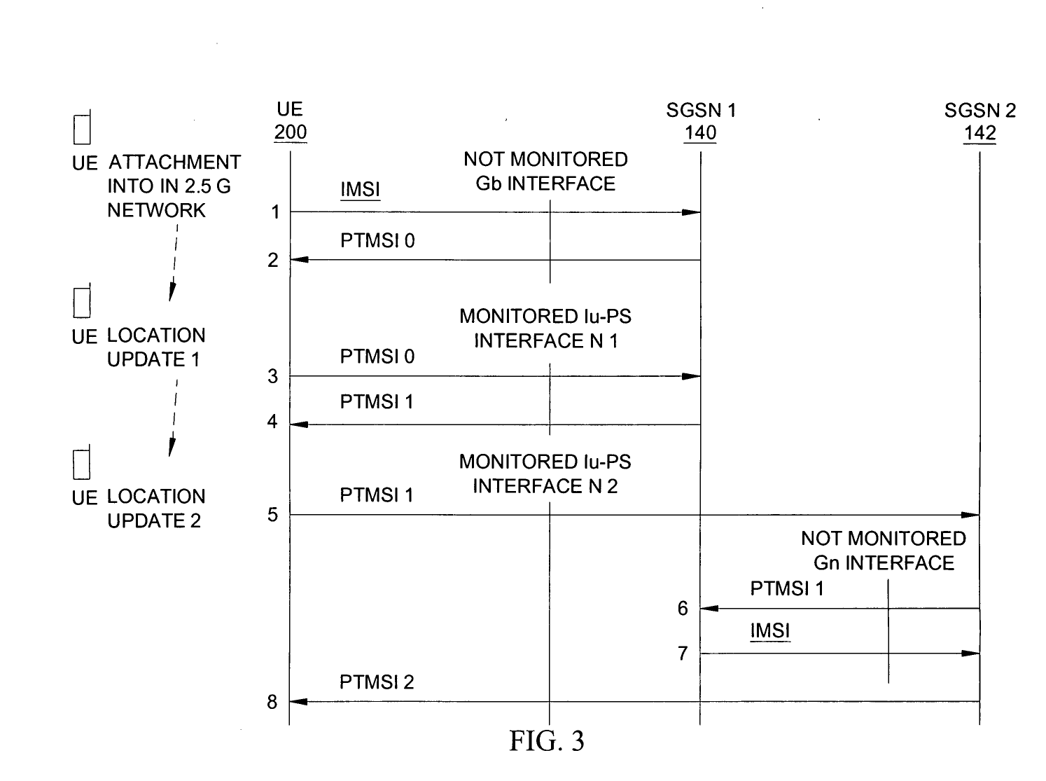

FIG. 3 is a message flow diagram corresponding to the example illustrated in FIG. 2. Referring to FIG. 3, in line 1, the user equipment communicates the IMSI to SGSN 140 when the user equipment attaches to the network. SGSN 140 generates a packet TMSI, referred to as PTMSI 0, and communicates PTMSI 0, to user equipment 200. However, this information is not recorded by the monitoring system because the Gb interface is not monitored.

In lines 3 and 4 of the data flow diagram, PTMSI 0 is communicated from user equipment 200 to SGSN 140, and SGSN 140 assigns PTMSI 1 to the user equipment. These messages may be observed by the monitoring system because they traverse one of the monitored interfaces. In line 5, in response to the second update location, PTMSI 1 is transmitted from the user equipment to SGSN 142. In line 6 and 7, PTMSI 1 and the IMSI are exchanged between SGSN 140 and SGSN 142 over the Gn interface, which is likewise not monitored. In line 8, PTMSI 2 is allocated to the user equipment and communicated to the user equipment.

Thus, in the example illustrated in FIG. 3, without using a mobile reference, the monitoring equipment will generate two different xDRs, one with PTMSI 0 and PTMSI 1 and another with PTMSI 1 and PTMSI 2. The successively generated xDRs, without the subject matter described herein, can only be referenced by the successive temporary identifiers. As such, to recover all xDRs relative to the particular user equipment, it would be required to perform queries on each of the identifiers. As a result, the processing burden and time required to perform these operations is great.

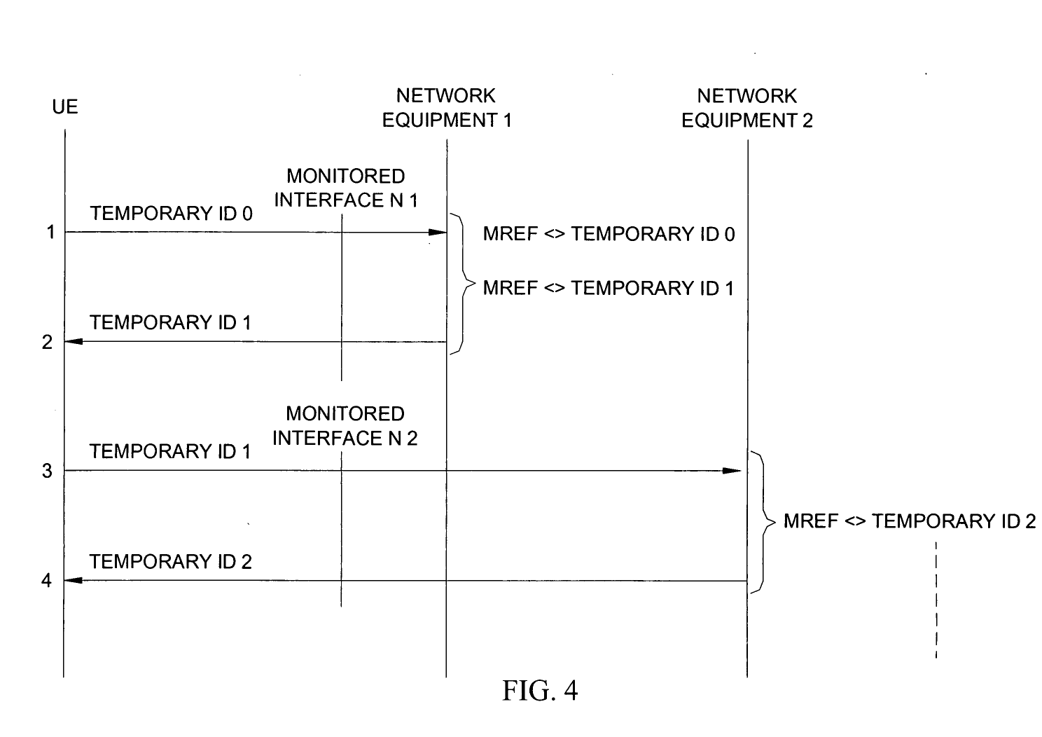

However, according to the present subject matter, a mobile reference may be assigned to each xDR at the time of its creation or shortly thereafter, 30 and xDRs associated with the same user equipment may be associated with the same mobile reference. FIG. 4 illustrates this concept. In the message flow diagram illustrated in FIG. 4, in lines 1 and 2, temporary identifiers 0 and 1 are observed on a monitored interface. A monitoring system according to an embodiment of the subject matter described herein may assign a mobile reference to temporary identifier 0, correlate temporary identifier 0 with temporary identifier 1, and associate the same mobile reference with temporary identifier 1. The correlation between temporary identifiers 0 and 1 may be performed by analyzing signaling messages that contain both temporary identifiers to make the association.

In lines 3 and 4 of the message flow diagram, temporary identifier 1 and another temporary identifier, temporary identifier 2, are observed in messages at monitored interface N 2. A monitoring system according to the subject matter described herein assigns the mobile reference to temporary identifier 2. Once these associations are performed and because the associations may be performed at the time of xDR creation, all xDRs generated for a given mobile station can be extracted with a simple filter of type MREF=(MREF identifier).

In one implementation, a monitoring system may generate an attachment xDR and allocate a new mobile reference to the attachment xDR. The monitoring system may then search for xDRs that are related to the same subscriber as the attachment xDR that have timestamps that are within a user-configurable time period of the timestamp of the attachment xDR. The user-configurable time period may extend before and after the timestamp of the attachment xDR. The monitoring system may pre-associate the located xDRs with a mobile reference to facilitate later retrieval.

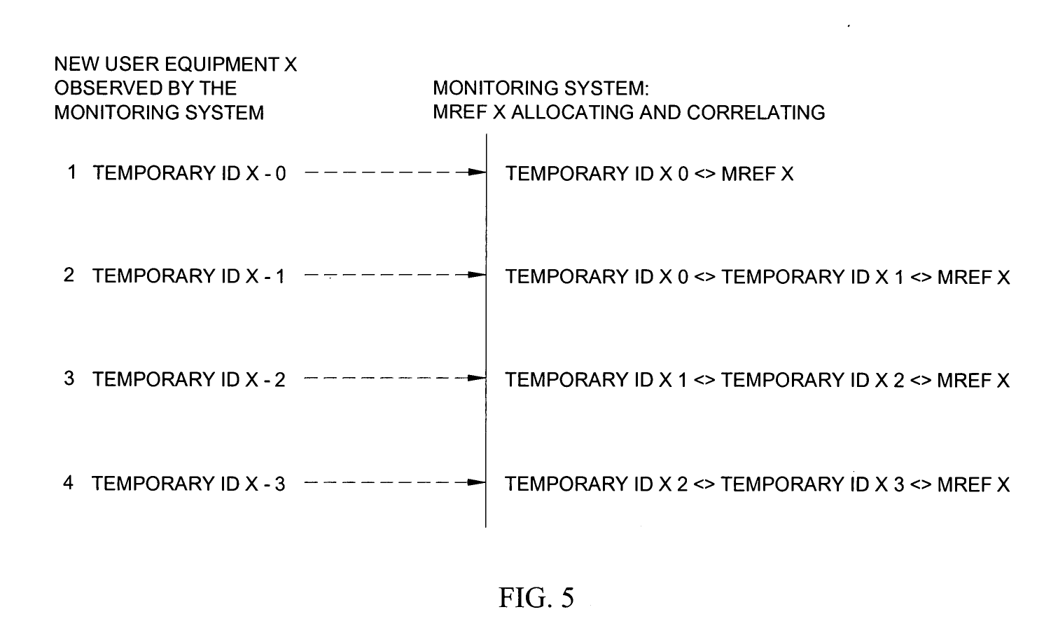

FIG. 5 illustrates a general data flow associated with assigning mobile references to temporary identifiers and correlating temporary identifiers. Referring to FIG. 5, in line 1, new user equipment X is observed by a monitoring system, and temporary ID X 0 is generated. The monitoring system allocates MREF X to temporary ID X 0. In line 2, the monitoring system observes temporary ID X 1. The monitoring system correlates temporary ID X 1 with temporary ID X 0, for example, by observing a message that contains both IDs. The monitoring system assigns MREF X to temporary IDs X 0 and X 1.

In line 3, the monitoring system observes temporary ID X 2 and correlates temporary ID X 2 with temporary ID X 1. The monitoring system assigns mobile reference X to this correlation. In line 4, the monitoring system observes temporary ID X 3 and correlates temporary ID X 3 with temporary ID X 2. The monitoring system associates mobile reference X with temporary IDs X 2 and X 3.

Accordingly, after line 4, the monitoring system can be queried using MREF X and locate records including temporary IDs X 0-X 3. The mobile reference can be used to retrieve xDRs generated on any type of interface and/or in any type of network. For example, xDRs may be generated at the any of interfaces illustrated in FIGS. 1 and 2, at the A interface, at a MAP interface, at a session initiation protocol (SIP) interface, at an IP multimedia subsystem (IMS) interface or other suitable interface.

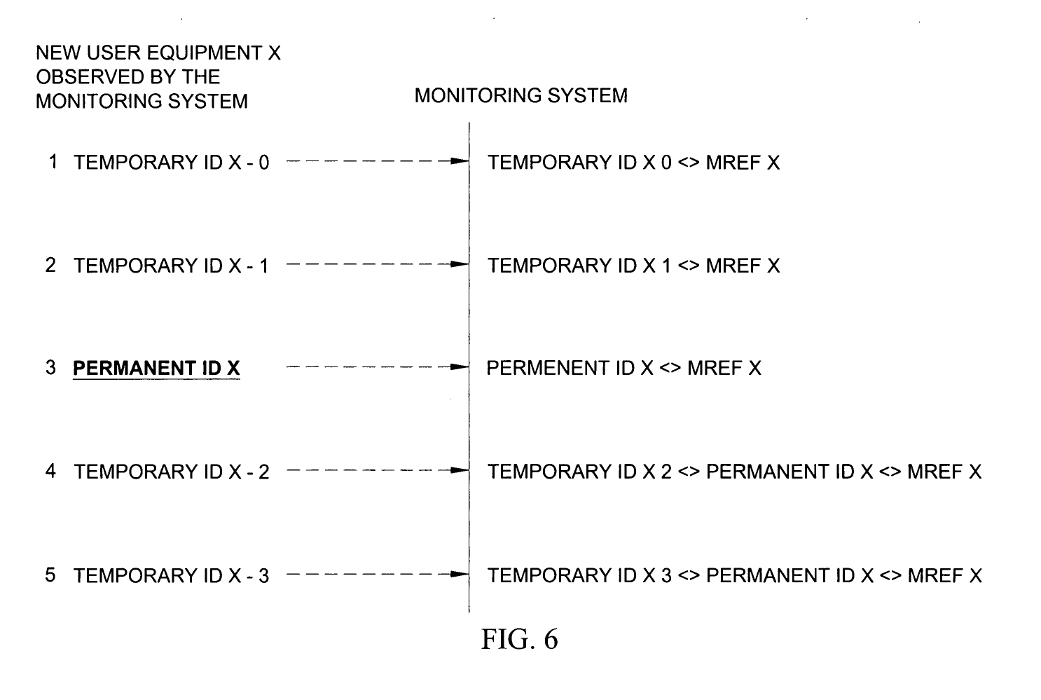

FIG. 6 is another example illustrating the benefit of using a mobile reference when a permanent identifier is observed. In FIG. 6, in line 1, the monitoring system observes temporary ID X 0 and assigns mobile reference X to temporary ID 0. In line 2, the monitoring system observes temporary ID X 1, correlates temporary ID X 1 with temporary ID X 0, and assigns mobile reference X to temporary ID X 1.

In line 3 of the message flow, a permanent ID X, such as an IMSI, is observed by the monitoring system. The monitoring system correlates permanent ID X with temporary ID X 1 and temporary ID X 0, and assigns mobile reference X to permanent ID X.

In lines 4 and 5, the monitoring system observes temporary IDs X 2 and X 3 and associates both of these with permanent ID X and mobile reference X.

In general, the permanent ID for a mobile station may be provided by the network during mobile reference management. In such a case, the permanent ID may be correlated with the allocated mobile reference, as illustrated in FIG. 3. One benefit of using a mobile reference with records that include a permanent ID is back correlation is avoided. For example, to recover all xDRs of the user equipment associated with a particular permanent identifier, an xDR can be located using the permanent identifier. The mobile reference corresponding to the permanent identifier can be determined. The mobile reference can then be used to get all of the other records corresponding to the permanent identifier. Without the mobile reference, only the IMSI would be used and back correlation would be required to recover any xDRs generated before IMSI observation.

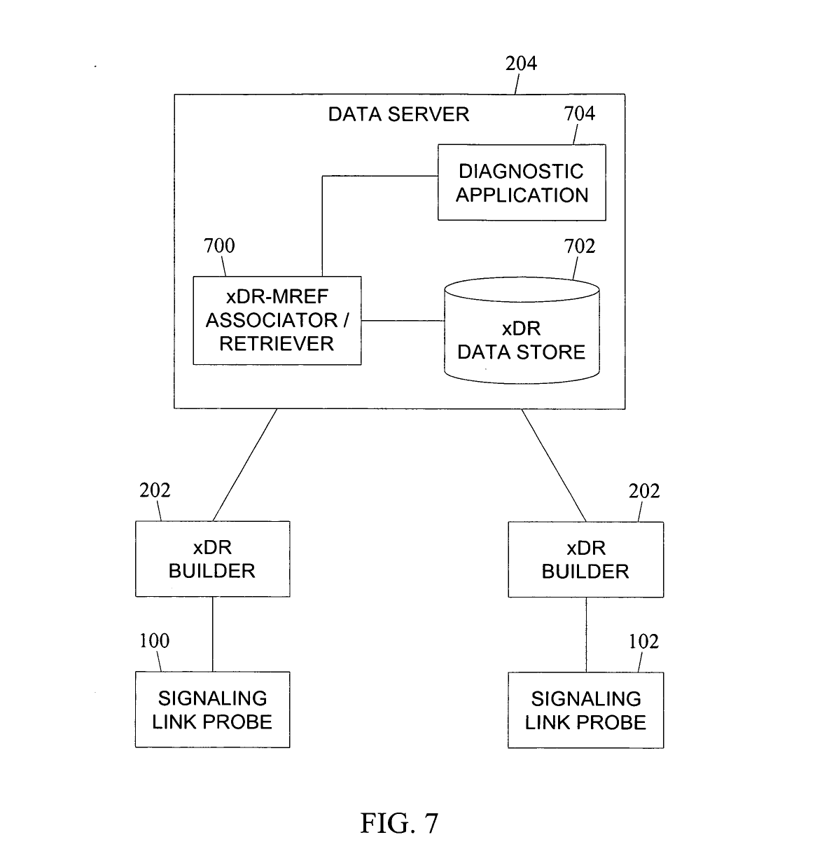

FIG. 7 is a block diagram illustrating an exemplary system for associating a mobile reference with communications detail records and for retrieving communications detail records corresponding to the mobile reference. Referring to FIG. 7, the system includes signaling link probes 100 and 102, xDR builders 202, and data server 204. Signaling link probes 100 and 102 may be any suitable signaling link probes that copy messages from signaling links or internally from a network node. xDR builders 202 include hardware and/or software that generate xDRs based on signaling message copies received from link probes 100 and 102. Data server 204 includes an XDR-MREF associator/retriever 700 for assigning mobile references to xDRs, for correlating xDRs, and for storing the xDRs and the associated mobile references in xDR data store 702. A diagnostic application 704 may access all xDRs corresponding to a particular mobile reference by constructing xDR-MREF associator/retriever 700 to query xDR data store using the mobile reference identifier as a search key.

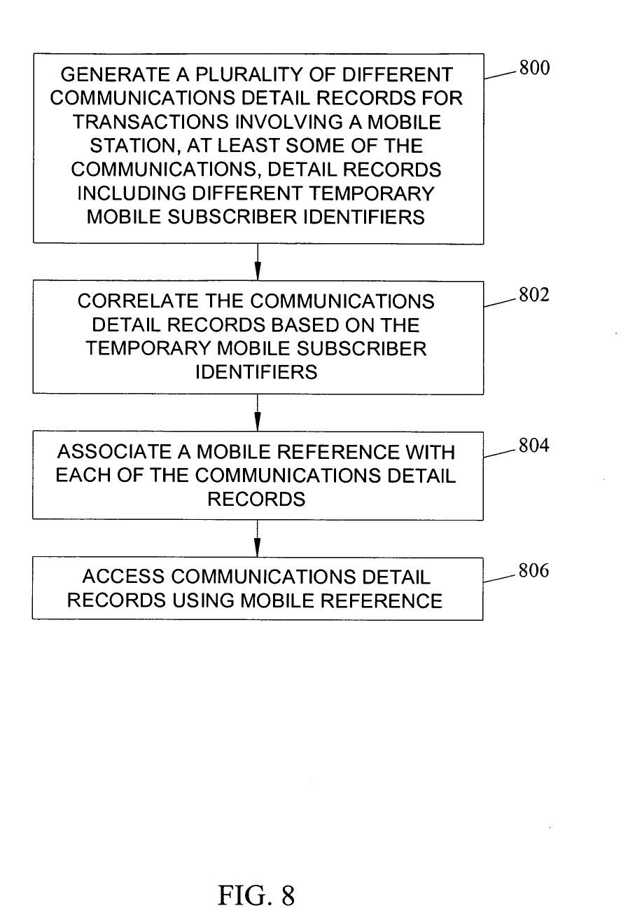

FIG. 8 is a flow chart illustrating an exemplary process for associating a mobile reference with a communication detail record and for retrieving communications detail records using the mobile reference according to an embodiment of the subject matter described herein. Referring to FIG. 8, in step 800, a plurality of different communications detail records for transactions involving a mobile station are generated. At least some of the communications detail records include temporary mobile subscriber identifiers. In step 802, the communications detail records are correlated based on the temporary mobile subscriber identifiers. In step 804, a mobile reference is associated with each of the communications detail records using the mobile reference.

In step 806, the communications detail records are accessed using the mobile reference. For example, diagnostic application 704 illustrated in FIG. 7 may issue a query for all xDRs involving MREF X. In response to the query, communications detail records associated with the mobile reference are retrieved. For example, XDR-MREF associator/retriever may use the mobile reference as a search key in xDR data store 702 to receive all xDRs associated with a particular mobile station. The retrieval may occur in real time because the records are pre-associated with the mobile reference.

It will be understood that various details of the invention may be changed without departing from the scope of the subject matter described herein. Furthermore, the foregoing description is for the purpose of illustration only, and not for the purpose of limitation.

What is claimed is:

1. A method for associating communications detail records with a mobile reference and for retrieving the communications detail records using the mobile reference, the method comprising:
(a) generating a plurality of different communications detail records for transactions involving a mobile station, at least some of the communications detail records including different temporary mobile subscriber identifiers;
(b) correlating the communications detail records based on the temporary mobile subscriber identifiers;
(c) associating a mobile reference with each of the communications detail records; and
(d) accessing the communications detail records using the mobile reference.

2. The method of claim 1 wherein the mobile reference comprises an identifier assigned by network monitoring equipment to a subscriber independently of assignment of permanent identifiers used by mobile communications network signaling nodes to identify the subscriber.

3. The method of claim 1 wherein generating a plurality of different communications detail records includes generating at least one transaction detail record (TDR) and at least one call detail record (CDR) associated with a mobile subscriber.

4. The method of claim 3 wherein generating at least one CDR and at least one TDR includes generating at least two of an attachment record, an update location record, a call record, a short message service record, and a handover record associated with the mobile subscriber.

5. The method of claim 1 wherein correlating the communications detail records based on the temporary mobile subscriber identifiers includes performing forward correlation based on a temporary mobile subscriber identifier identified in a first communications detail record.

6. The method of claim 5 wherein correlating the communications detail records includes performing backward correlation based on the temporary mobile subscriber identifier in the communications detail record.

7. The method of claim 1 wherein associating the communications detail records with the mobile reference includes pre-associating the communications detail records with the mobile reference to facilitate later retrieval.

8. The method of claim 1 wherein correlating the communications detail records includes correlating records made based on different network types wherein at least some of the records do not include an international mobile subscriber identity (IMSI).

9. The method of claim 1 wherein the temporary mobile subscriber identifiers include at least one identifier selected from the group consisting of a temporary mobile subscriber identity (TMSI), a packet TMSI (PTMSI), a packet data protocol (PDP) IP address, a serving radio network controller network temporary identifier (S-RNTI), a controlling RNTI (C-RNTI), a temporary logical link identifier (TLLI) and a UMTS terrestrial radio access network (UTRAN) RNTI.

10. The method of claim 1 wherein associating a mobile reference with each of the communications detail records includes storing the mobile reference in each of the communications detail records in a data store managed by a server.

11. The method of claim 1 wherein accessing the communications detail records using the mobile reference includes:
(a) receiving a query including the mobile reference; and
(b) in response to the query, retrieving the communications detail records using the mobile reference.

12. The method of claim 11 wherein receiving a query for retrieving the communications detail records associated with the mobile reference includes receiving a query from a diagnostic application.

13. The method of claim 11 wherein retrieving the communications detail records includes performing a database lookup using the mobile reference as a search key and locating all of the communications detail records associated with the mobile reference.

14. The method of claim 13 wherein retrieving the communications detail records using the mobile reference includes retrieving the communications detail records in real time.

15. A system for associating and retrieving communications detail records using a mobile reference, the system comprising:
(a) at least one communications detail record builder for generating a plurality of different communications detail records for transactions involving a mobile station, at least some of the communications detail records including different temporary mobile subscriber identifiers; and
(b) a communications detail record-mobile reference associator/retriever for correlating the communications detail records based on the temporary mobile subscriber identifiers, for associating a mobile reference with the each of the communications detail records, and for accessing the communications detail records using the mobile reference.

16. The system of claim 15 wherein the mobile reference comprises an identifier assigned by network monitoring equipment to a subscriber independently of assignment of permanent identifiers used by mobile communications network signaling nodes to identify the subscriber.

17. The system of claim 15 wherein the at least one communications detail record builder is adapted to generate at least one of call detail records and transaction detail records associated with the mobile subscriber. A

18. The system of claim 17 wherein the at least one communications detail record builder is adapted to generate at least two of an attachment record, an update location record, a call record, a short message service record, a multimedia message service record and a handover record associated with the mobile subscriber.

19. The system of claim 15 wherein the communications detail record-mobile reference associator/retriever is adapted to perform backward correlation to locate communication detail records corresponding to a temporary mobile subscriber identifier.

20. The system of claim 15 wherein the communications detail record-mobile reference associator/retriever is adapted to perform forward correlation to locate communication detail records corresponding to a temporary mobile subscriber identifier.

21. The system of claim 15 wherein the communications detail record-mobile reference associator/retriever is adapted to pre-associate the communications detail records with the mobile reference to facilitate later retrieval.

22. The system of claim 15 wherein the communications detail record-mobile reference associator/retriever is adapted to generate communications detail records associated with messages of different network types, wherein some of the records do not include an international mobile subscriber identity (IMSI).

23. The system of 15 wherein the temporary mobile subscriber identifiers include at least one identifier selected from the group consisting of a temporary mobile subscriber identity (TMSI), a packet TMSI (PTMSI), a packet data protocol (PDP) IP address, a serving radio network controller network temporary identifier (S-RNTI), a controlling RNTI (C-RNTI), a temporary logical link identifier (TLLI) and a UMTS terrestrial radio access network (UTRAN) RNTI.

24. The system of claim 15 comprising a communications detail record data store, wherein the communications detail record-mobile reference associator/retriever is adapted to store the communications detail records and their associated mobile reference values in the data store.

25. The system of claim 24 comprising a diagnostic application for generating a query for records involving the mobile reference.

26. The system of claim 24 wherein the communications detail record-mobile reference associator/retriever is adapted to extract records from the data store using the mobile reference as a lookup key.

27. The system of claim 26 wherein the communications detail record-mobile reference associator/retriever is adapted to extract all records corresponding to the mobile reference real time.

28. A computer program product comprising computer executable instructions embodied in computer readable medium for performing steps comprising:
(a) generating a plurality of different communications detail records for transactions involving a mobile station, at least some of the communications detail records including different temporary mobile subscriber identifiers;
(b) correlating the communications detail records based on the temporary mobile subscriber identifiers;
(c) associating a mobile reference with each of the communications detail records; and
(d) accessing the communications detail records using the mobile reference.

29. The computer program product of claim 28 wherein the mobile reference comprises an identifier assigned by network monitoring equipment to a subscriber independently of assignment of permanent identifiers used by mobile communications network signaling nodes to identify the subscriber.

30. The computer program product of claim 28 wherein generating a plurality of different communications detail records includes generating a plurality of transaction detail records (TDRs) and call detail records (CDRs) associated with a mobile subscriber.

31. The computer program product of claim 30 wherein generating a plurality of TDRs and at least one CDR includes generating at least two of an attachment record, an update location record, a call record, a short message service record, and a handover record associated with the mobile subscriber.

32. The computer program product of claim 28 wherein correlating the communications detail records based on the temporary mobile subscriber identifiers includes performing forward correlation based on a temporary mobile subscriber identifier identified in a first communications detail record.

33. The computer program product of claim 32 wherein correlating the communications detail records includes performing backward correlation based on the temporary mobile subscriber identifier in the communications detail record.

34. The computer program product of claim 28 wherein associating the communications detail records with the mobile reference includes pre-associating the communications detail records with the mobile reference to facilitate later retrieval.

35. The computer program product of claim 28 wherein correlating the communications detail records includes correlating records made based on different network types wherein at least some of the records do not include an international mobile subscriber identity (IMSI).

36. The computer program product of claim 28 wherein the temporary mobile subscriber identifiers include at least one identifier selected from the group consisting of a temporary mobile subscriber identity (TMSI), a packet TMSI (PTMSI), a packet data protocol (PDP) IP address, a serving radio network controller network temporary identifier (S-RNTI), a controlling RNTI (C-RNTI), a temporary logical link identifier (TLLI), and a UMTS terrestrial radio access network (UTRAN) RNTI.

37. The computer program product of claim 28 wherein associating a mobile reference with each of the communications detail records includes storing the mobile reference in each of the communications detail records in a data store managed by a server.

38. The computer program product of claim 28 wherein accessing the communications detail records using the mobile reference comprises:
(a) receiving a query including the mobile reference; and
(b) in response to the query, retrieving the communications detail records using the mobile reference.

39. The computer program product of claim 38 wherein receiving a query for retrieving the communications detail records associated with the mobile reference includes receiving a query from a diagnostic application.

40. The computer program product of claim 38 wherein retrieving the communications detail records includes performing a database lookup using the mobile reference as a search key and locating all of the communications detail records associated with the mobile reference.

41. The computer program product of claim 40 wherein retrieving the communications detail records using the mobile reference includes retrieving the communications detail records in real time.
